(19) United States
(12) Patent Application Publication
(10) Pub. No.: US 2016/0150158 A1
(43) Pub. Date: May 26, 2016

(54) PHOTOGRAPHING APPARATUS AND METHOD FOR CONTROLLING THEREOF

(71) Applicant: SAMSUNG ELECTRONICS CO., LTD., Suwon-si (KR)

(72) Inventors: Muhammad Kamrul HASAN, Suwon-si (KR); Kai GUO, Suwon-si (KR); Duck-chan SEO, Yongin-si (KR); Nak-hoon KIM, Suwon-si (KR)

(73) Assignee: SAMSUNG ELECTRONICS CO., LTD., Suwon-si (KR)

(21) Appl. No.: 14/812,801

(22) Filed: Jul. 29, 2015

(30) Foreign Application Priority Data
Nov. 24, 2014 (KR) 10-2014-0164489

(51) Int. Cl. H04N 5/232

(52) U.S. Cl. CPC H04N 5/23258; H04N 5/2329; H04N 5/23267

(57) ABSTRACT

Provided is a photographing apparatus including: a photographer configured to photograph a moving image; a sensor configured to detect shaking of the photographing apparatus; an image processor configured to correct a photographed frame of the photographed moving image; and a controller configured to determine a processing mode for processing the photographed moving image based on at least one of shaking information of the photographing apparatus which is detected through the sensor and motion estimation information of the photographed moving image, and to control the image processor to process the moving image in the determined processing mode.

### CROSS-REFERENCE TO RELATED APPLICATION

This application claims priority from Korean Patent Application No. 10-2014-0164489 filed on Nov. 24, 2014 in the Korean Intellectual Property Office, the disclosure of which is incorporated herein by reference in its entirety.

### BACKGROUND

1. Field

Apparatuses and methods consistent with exemplary embodiments relate to a photographing apparatus and a method for controlling thereof, and more particularly, to a photographing apparatus which can determine a video stabilization processing mode based on sensor information and motion estimation information, and a method for controlling thereof.

2. Description of the Related Art

With the advancement of image processing technology, technology for correcting frames of a moving image photographed by a photographing apparatus on a real time basis is also developing. The technology for processing images by considering shaking, a motion, and the like of the photographing apparatus is referred as video stabilization technology.

However, there is a problem that the photographing apparatus requires excessive power consumption to stabilize a video and correct rolling shutter distortion on a real time basis. Because high-performance algorithms for stabilization require comprehensive calculation, power consumption increases. As the photographing apparatus is implemented as a mobile device or miniaturized, power of a battery mounted in the photographing apparatus has a limit and thus the problem of power consumption requires more attention.

To mitigate this problem, a method for reducing stabilization strength in a tripod mode has been suggested. However, the tripod mode is not a solution to reduce power consumption and there is also a problem that the tripod mode is rarely used in a general moving image photographing scenario.

In addition, no measure is prepared in case that a stabilization function is sacrificed in relation to the system of the photographing apparatus.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a determination method which classifies moving image photographing scenarios and processes images in different processing modes, and an image correction method for reducing power consumption.

According to an aspect of an exemplary embodiment, there is provided a photographing apparatus, including: a photographer configured to photograph a moving image; a sensor configured to detect shaking of the photographing apparatus when the moving image is photographed; an image processor configured to correct a photographed frame; and a controller configured to determine a processing mode for photographing the moving image based on at least one of shaking information of the photographing apparatus which is detected through the sensor and motion estimation information of the photographed moving image, and control the image processor to process the moving image in the determined processing mode.

The controller may be configured to compare a value extracted from the shaking information and a first threshold, and, in response to the value being less than or equal to the first threshold, analyze the motion estimation information and determine the processing mode for photographing the moving image, and, in response to the value exceeding the first threshold, compare the value extracted from the shaking information and a second threshold and determine the processing mode for photographing the moving image.

The controller may be configured to analyze the motion estimation information, and, in response to a number of unidirectional motion data being less than or equal to a predetermined number, control the image processor to process the image in a first processing mode, and, in response to the number of unidirectional motion data exceeding the predetermined number, control the image processor to process the image in a second processing mode.

In response to the value extracted from the shaking information exceeding the second threshold, the controller may be configured to control the image processor to process the image in a first processing mode, and, in response to the value being less than or equal to the second threshold, control the image processor to process the image in a second processing mode.

In response to the determined processing mode being a first processing mode, the controller may be configured to control the image processor to process correction with respect to only a translation motion by performing dynamic crop with a translation motion offset.

The translation motion offset may be determined based on shaking information detected by the sensor, and the dynamic crop may determine a pixel from which image processing starts using the translation motion offset and crops the image.

The photographing apparatus may further include: an input frame buffer configured to store a pre-image processing frame; and an output frame buffer configured to store a post-image processing frame, and the controller may be configured not to store the photographed frame in the input frame buffer and to directly store a frame which undergoes correction processing only for the translation motion in the output frame buffer.

The motion estimation information may be information which is estimated based on a result of image processing of previous frames.

The controller may be configured to monitor a status of the photographing apparatus, and, in response to the monitored status of the photographing apparatus reaching a predetermined reference, determine the processing mode as a first processing mode regardless of the shaking information and the motion estimation information, and control the image processor to process the image in the first processing mode.

The monitored status of the photographing apparatus may be at least one of a battery level, a temperature level, a CPU active core, ambient light, and a zoom level.

According to an aspect of another exemplary embodiment, there is provided a method for controlling a photographing apparatus, including: detecting shaking of the photographing apparatus when a moving image is photographed; determining a processing mode for photographing the moving image based on at least one of the detected shaking information of the photographing apparatus and motion estimation information of the photographed moving image; and processing the moving image in the determined processing mode.

The determining may include comparing a value extracted from the shaking information and a first threshold, and, in response to the value being less than or equal to the first threshold, analyzing the motion estimation information and determining the processing mode for photographing the moving image, and, in response to the value exceeding the first threshold, comparing the value extracted from the shaking information and a second threshold and determining the processing mode for photographing the moving image.

The determining may include analyzing the motion estimation information, and, in response to a number of unidirectional motion data being less than or equal to a predetermined number, determining the processing mode as a first processing mode, and, in response to the number of unidirectional motion data exceeding the predetermined number, determining the processing mode as a second processing mode.

The determining may include, in response to the value extracted from the shaking information exceeding the second threshold, determining the processing mode as a first processing mode, and, in response to the value being less than or equal to the second threshold, determining the processing mode as a second processing mode.

The processing may include, in response to the determined processing mode being a first processing mode, processing correction with respect to only a translation motion by performing dynamic crop with a translation motion offset.

The translation motion offset may be determined based on the detected shaking information, and the dynamic crop may determine a pixel from which image processing starts using the translation motion offset and crops the image.

The processing may include not storing the photographed frame in an input frame buffer and directly storing a frame which undergoes correction processing only for the translation motion in an output frame buffer.

The motion estimation information may be information which is estimated based on a result of image processing of previous frames.

The determining may include monitoring a status of the photographing apparatus, and, in response to the monitored status of the photographing apparatus reaching a predetermined reference, determining the processing mode as a first processing mode regardless of the shaking information and the motion estimation information.

The monitored status of the photographing apparatus may be at least one of a battery level, a temperature level, a CPU active core, ambient light, and a zoom level.

According to various exemplary embodiments as described above, the photographing apparatus can stabilize a video and optimize correction of rolling shutter distortion on a real time basis. The photographing apparatus does not correct all the image frames in the same method and selects a frame which can be processed by minimum correction, so that the power of the photographing apparatus can be effectively used. In addition, the size of a battery can be reduced while the same performance is achieved, so that the photographing apparatus can be miniaturized.

According to an aspect of yet another exemplary embodiment, there is provided a photographing apparatus including: a photographer configured to photograph a moving image; a sensor configured to detect shaking of the photographing apparatus; an image processor configured to correct a photographed frame of the photographed moving image; and a controller configured to determine a processing mode for processing the photographed moving image based on at least one of shaking information of the photographing apparatus which is detected through the sensor and motion estimation information of the photographed moving image, and to control the image processor to process the moving image in the determined processing mode.

The controller may be configured to compare a value extracted from the shaking information and a first threshold, and, in response to the value being less than or equal to the first threshold, the controller is configured to analyze the motion estimation information and to determine the processing mode for processing the photographed moving image, and, in response to the value exceeding the first threshold, the controller may be configured to compare the value extracted from the shaking information and a second threshold and to determine the processing mode for processing the photographed moving image.

The controller may be configured to analyze the motion estimation information, and, in response to a number of unidirectional motion data being less than or equal to a predetermined number, the controller may be configured to control the image processor to process the image in a first processing mode, and, in response to the number of unidirectional motion data exceeding the predetermined number, the controller may be configured to control the image processor to process the image in a second processing mode.

In response to the value extracted from the shaking information exceeding the second threshold, the controller may be configured to control the image processor to process the image in a first processing mode, and, in response to the value being less than or equal to the second threshold, the controller may be configured to control the image processor to process the image in a second processing mode.

In response to the determined processing mode being a first processing mode, the controller may be configured to control the image processor to process correction of the moving image with respect to only a translation motion by performing dynamic crop with a translation motion offset.

The controller may be configured to determine the translation motion offset based on the shaking information detected by the sensor, and wherein the dynamic crop may determine a pixel from which image processing starts using the translation motion offset and crops the image.

The photographing apparatus may further include: an input frame buffer configured to store a pre-image processing frame; and an output frame buffer configured to store a post-image processing frame, and wherein the controller is configured to store a frame which undergoes correction processing only for the translation motion only in the output frame buffer amongst the input frame buffer and the output frame buffer.

The motion estimation information may be information which is estimated based on a result of image processing of preceding frames of the photographed frame.

The controller may be configured to monitor a status of the photographing apparatus, and, in response to the monitored status of the photographing apparatus reaching a predetermined threshold, the controller may be configured to determine the processing mode as a first processing mode regardless of the shaking information and the motion estimation information, and to control the image processor to process the image in the first processing mode.

The monitored status of the photographing apparatus may include at least one of a battery level, a temperature level, a CPU active core, ambient light, and a zoom level.

According to an aspect of yet another exemplary embodiment, there is provided a method for controlling a photographing apparatus, the method including: detecting, by a sensor, shaking of the photographing apparatus when photographing a moving image; determining, by a controller, a processing mode for processing the moving image based on at least one of the detected shaking information of the photographing apparatus and motion estimation information of the photographed moving image; and processing, by at least one processor, the moving image in the determined processing mode.

The determining may include comparing a value extracted from the shaking information and a first threshold, and, in response to the value being less than or equal to the first threshold, analyzing the motion estimation information and determining the processing mode for processing the moving image, and, in response to the value exceeding the first threshold, comparing the value extracted from the shaking information and a second threshold and determining the processing mode for photographing the moving image.

The determining may include analyzing the motion estimation information, and, in response to a number of unidirectional motion data being less than or equal to a predetermined number, determining the processing mode as a first processing mode, and, in response to the number of unidirectional motion data exceeding the predetermined number, determining the processing mode as a second processing mode.

The determining may include, in response to the value extracted from the shaking information exceeding the second threshold, determining the processing mode as a first processing mode, and, in response to the value being less than or equal to the second threshold, determining the processing mode as a second processing mode.

The processing may include, in response to the determined processing mode being a first processing mode, processing correction of the moving image with respect to only a translation motion by performing dynamic crop with a translation motion offset.

The translation motion offset may be determined based on the detected shaking information, and the dynamic crop may determine a pixel from which image processing starts using the translation motion offset and crops the image.

The processing may include storing a frame which undergoes correction processing only for the translation motion in an output frame buffer amongst the output frame buffer and an input frame buffer.

The determining may include monitoring a status of the photographing apparatus, and, in response to the monitored status of the photographing apparatus reaching a predetermined threshold, determining the processing mode as a first processing mode regardless of the shaking information and the motion estimation information.

### BRIEF DESCRIPTION OF THE DRAWINGS

The above and/or other aspects, features, and advantages of the disclosure will be more apparent from the following description taken in conjunction with the accompanying drawings, in which:

FIG. 1 is a schematic block diagram showing a configuration of a photographing apparatus according to an exemplary embodiment;

FIG. 2 is a block diagram to illustrate a configuration of a photographing apparatus in detail according to an exemplary embodiment;

FIGS. 3A to 3D are views to illustrate various scenarios to compensate for a motion;

FIG. 4 is a view showing shaking information which is detected by a sensor of a photographing apparatus according to an exemplary embodiment;

FIG. 5 is a view to illustrate translation motion correction processing in a first processing mode according to an exemplary embodiment;

FIG. 6 is a flowchart to illustrate a method for controlling a photographing apparatus according to an exemplary embodiment;

FIG. 7 is a flowchart to illustrate processing mode determination according to an exemplary embodiment;

FIG. 8 is a flowchart to illustrate image processing in a first processing mode according to an exemplary embodiment;

FIG. 9 is a flowchart to illustrate image processing in a second processing mode according to an exemplary embodiment; and

FIG. 10 is a flowchart to illustrate a method for controlling a photographing apparatus according to another exemplary embodiment.

### DETAILED DESCRIPTION

Hereinafter, exemplary embodiments will be described in greater detail with reference to the accompanying drawings. In the following description, well-known functions or constructions are not described in detail because they would obscure the invention in unnecessary detail. Also, the terms used herein are defined according to the functions of the present invention. Thus, the terms may vary depending on user's or operator's intension and usage. That is, the terms used herein must be understood based on the descriptions made herein.

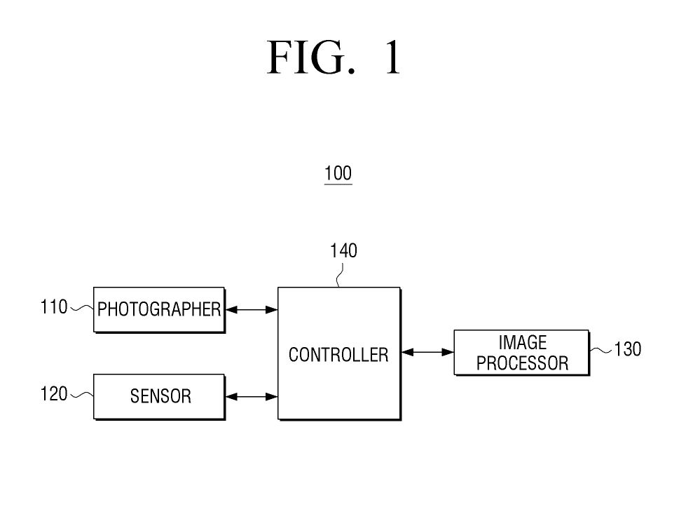

FIG. 1 is a schematic block diagram to illustrate a configuration of a photographing apparatus 100 according to an exemplary embodiment. Referring to FIG. 1, the photographing apparatus 100 includes a photographer 110, a sensor 120, an image processor 130, and a controller 140. The photographing apparatus 100 according to an exemplary embodiment may be implemented by using various electronic devices equipped with a moving image photographing function, such as a digital camera, a camcorder, a smartphone, a Portable Multimedia Player (PMP), smart glasses, a tablet PC, a smart watch, a webcam, a black box, etc.

The photographer 110 photographs a moving image in a rolling shutter method. Specifically, the photographer 110 may include a lens for collecting light of a subject and focusing an optical image on a photographing area, a photographing element for optically converting light entering through the lens into electric signals, and an Analogue-Digital (AD) converter for converting analogue signals of the photographing element into digital signals and outputting the digital signals.

The sensor 120 detects shaking, vibration or motion/movement of the photographing apparatus 100 when the photographing apparatus 100 photographs a moving image. For example, the sensor 120 may be implemented by using a gyro sensor which provides an angular velocity. The gyro sensor may provide the angular velocity at three axes according to the motion of the photographing apparatus 100.

The image processor 130 corrects a photographed image frame. For example, the image processor 130 may compensate for a translation motion, a rotational motion, or distortion caused by a rolling shutter.

The controller 140 controls the overall configuration of the photographing apparatus 100. According to an exemplary embodiment, the controller 140 may determine a processing mode for photographing a moving image based on motion estimation information which is estimated by analyzing shaking information of the photographing apparatus 100 detected through the sensor 120 and previous frames of the photographed moving image. For example, in response to determining that correction is not helpful to video stabilization because there is little motion or there is an excessive motion, power consumption can be reduced by performing simple compensation processing. In addition, the controller 140 may control the image processor 130 to process the image moving in the determined processing mode.

According to an exemplary embodiment, the controller 140 may monitor the status of the photographing apparatus 100. For example, the controller 140 may monitor a battery level, a temperature level, a number of CPU active cores, ambient light, and a zoom level including a digital zoom of the photographing apparatus 100. In response to the status of the photographing apparatus 100 reaching a predetermined threshold, the controller 140 may determine the processing mode as a first processing mode.

The first processing mode is a processing mode which is determined when it is determined that it is more effective to reduce power consumption than to process image correction. For example, when the photographing apparatus 100 is scarcely shaken, the image correction processing is not required or the image correction processing is of no effect on improvement of image quality. Therefore, the controller 140 changes the mode to the first processing mode to perform simple correction. A second processing mode is a processing mode to perform general image correction processing.

As described above, the user can photograph the moving image having no difference in view of image quality much longer with the same battery power through the photographing apparatus 100.

Hereinafter, a case in which a moving image is photographed will be mainly described. However, the photographing apparatus 100 according to an exemplary embodiment can be applied to a case in which a still image is photographed. For example, when the user photographs a still image while viewing a corrected screen provided as a live view, the photographing apparatus 100 may provide a live view screen which is processed in the first processing mode or the second processing mode based on information such as information on the degree of shaking of the photographing apparatus 100.

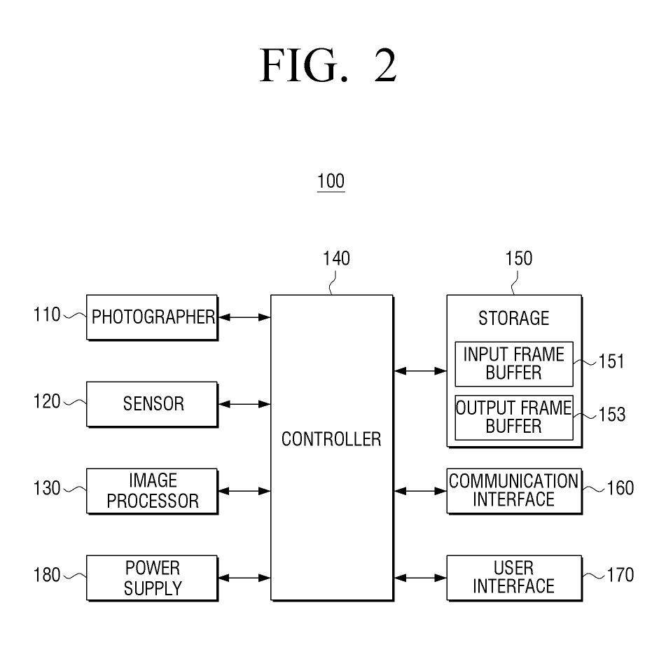

FIG. 2 is a block diagram to illustrate a configuration of a photographing apparatus 100 in detail according to an exemplary embodiment. Referring to FIG. 2, the photographing apparatus 100 includes a photographer 110, a sensor 120, an image processor 130, a controller 140, a storage 150, a communication interface 160, a user interface 170, and a power supply 180.

The photographer 110 continuously photographs a plurality of image frames in a rolling shutter method. The photographer 110 may include a lens, a photographing element, and an AD converter. The photographing element refers to a part which generates an image in a mobile phone camera, a Digital Still Camera (DSC) or the like. The representative photographing element is a Charge Coupled Device (CCD) and a Complementary Metal Oxide Semiconductor (CMOS). The CCD is an element in which respective Metal-Oxide-Silicon (MOS) capacitors are located in close proximity to one another and a charge carrier is stored in a capacitor and transferred. The CMOS image sensor is an element which employs a switching method, in which as many MOS transistors as the number of pixels are made using CMOS technology using a control circuit and a signal processing circuit as a peripheral circuit, and outputs are detected one by one using the MOS transistors. The CMOS image sensor is manufactured by a CMOS process which produces a general silicon semiconductor, and thus has advantages of a small size, a low price, and low power consumption. Hereinafter, exemplary embodiments using the CMOS image sensor will be mainly explained. However, because the photographing apparatus and the method for controlling thereof can be applied to a photographing apparatus using a CCD element, exemplary embodiments are not limited to the case in which the CMOS image sensor is used.

As a method for reading an optical image of a subject focused on a photographing area of the photographing element, there are a global shutter method and a rolling shutter method. The global shutter method is a method in which all the pixels of the photographing area read the optical image simultaneously. On the other hand, the rolling shutter method is a method in which one or more pixels in the photographing area read the optical image serially. The CMOS photographing element may apply both the global shutter method and the rolling shutter method. When the global shutter method is applied, all the pixels read the optical image of the subject simultaneously and thus a photographed image is not deformed even when the subject moves. On the other hand, because the CMOS photographing element to which the rolling shutter method is applied has one or several pixels read the optical image serially and thus a photographed image may be deformed when the subject moves or the photographing apparatus moves. Therefore, when a moving subject is photographed, the photographing apparatus applying the rolling shutter method requires correction processing due to rolling shutter distortion.

Each of the pixels of the photographing element includes a CMOS optical sensor. Each of the pixels of the photographing element reads the optical image in the rolling shutter method. Hereinafter, a case in which a rolling shutter reads an optical image in the unit of a single pixel will be explained by way of an example. However, exemplary embodiments can be applied to a case in which an optical image is read in the unit of a pixel line or in the unit of a combination of a plurality of pixel lines.

The sensor 120 detects shaking, vibration or movement/motion of the photographing apparatus 100 when a moving image is photographed. The sensor 120 may be implemented by using a gyro sensor which provides an angular velocity. The gyro sensor provides the angular velocity at three axes according to the motion of the photographing apparatus 100. The photographing apparatus 100 may compensate for the shaking by the rotational motion using angular velocity information detected by the gyro sensor.

According to an exemplary embodiment, the photographing apparatus 100 may determine a pixel from which dynamic crop starts using the angular velocity information detected by the gyro sensor. The degree of translation motion of the photographing apparatus when a first frame and a second frame are photographed is calculated by multiplying the detected angular velocity by a time between a focal length and frame photographing. The dynamic crop is used in the first processing mode and will be explained in detail later.

The image processor 130 corrects the photographed image frame. According to an exemplary embodiment, in response to determining that the image is processed in the first processing mode, the image processor 130 may process motion compensation with respect to only the translation motion. On the other hand, in response to determining that the image is processed in the second processing mode, the image processor 130 may process motion compensation with respect to the translation motion, rotational motion, or distortion caused by the rolling shutter.

For example, the image processor 130 may compensate for the movement of the photographing apparatus 100 by calculating displacement on an x-axis and a y-axis of each pixel using the shaking information detected by the sensor 120. In an exemplary embodiment, the image processor 130 may compensate for the movement of the photographing apparatus 100 based on motion estimation information. The motion estimation information is information for grasping movement displacement between a plurality of images by comparing a plurality of frames with one another, and estimating a motion in a next frame photographing operation.

The storage 150 stores respective image frames of the photographed moving image. The storage 150 may include an input frame buffer 151 and an output frame buffer 153. For example, the storage 150 may store the frames outputted from the photographer 100 in the input frame buffer 151. In addition, the storage 150 may store the image processed by the image processor 130 in the output frame buffer 153. In addition, the storage 150 may store a content finally generated by the image processor 130 (for example, a moving image in which a plurality of image frames are compressed). Although the input frame buffer 151 and the output frame buffer 153 are different elements in FIG. 2, pre-image processing frames and post-image processing frames may be stored in the single storage 150.

The storage 150 may store only a specific frame of the post-image processing image. For example, when the user photographs a still image while viewing a screen provided as a live view, the post-image processing image is shown on a real time basis through the live view, but only a specifically selected frame may be stored as a still image like a still cut. The storage 150 does not store the other frames which are not selected. The other frames which are not selected are just provided to the user through the live view. The specifically selected frame may be selected by a user input which is input through the user interface 170 or may be selected without a user input because the frame is determined as the best frame satisfying a predetermined condition.

The storage 150 may be implemented by using an internal storage medium and an external storage medium of the photographing apparatus 100. For example, the storage 150 may be implemented by using a memory card. The memory card is mountable in or dismountable from the photographing apparatus 100. In an exemplary embodiment, the storage 150 may be implemented by using a Universal Serial Bus (USB) memory, a removable disk including a flash memory, a storage medium connected to the photographing apparatus 100, or a web server through a network.

The communication interface 160 transmits the content stored in the photographing apparatus 100 to an external apparatus. For example, the communication interface 160 may transmit a moving image file stored in the storage 150 to an external apparatus or a server. The communication interface 160 may be implemented by using a wire method such as a USB port or a short-distance communication method such as Bluetooth, Infrared (IR) communication, Near Field Communication (NFC), Zigbee, WiFi Direct, or the like. In addition, the communication interface 160 may be implemented by using a long-distance communication method such as cellular communication, 3G mobile communication, Long Term Evolution (LTE), LTE-Advanced (LTE-A), or the like.

The user interface 170 allows the user to set or select various functions supported by the photographing apparatus 100. The user interface 170 may be implemented by using a device which implements an input and an output simultaneously like a touch pad, or may be implemented by combining an input device such as a plurality of buttons and a display device such as a Liquid Crystal Display (LCD) monitor, an Organic Light Emitting Diode (OLED) monitor, or the like.

The user interface 170 may receive various control commands such as a photographing start command, a photographing end command, or the like from the user. In addition, the user interface 170 may receive settings related to photographing. For example, the user interface 170 may be receive, from the user, settings on in which file format the photographed moving image is stored, a resolution of the photographed image, a frame rate, whether a digital zoom is performed, AWB, AF, AE, or the like.

In addition, the user interface 170 may display the photographed image. For example, when the photographing apparatus 100 is photographing a moving image, the user interface 170 may display the moving image photographed by the photographer 110, and may display various contents stored in the storage 150 according to a user's reproduction command.

The power supply 180 supplies power to the respective elements of the photographing apparatus 100. For example, the power supply 180 may be implemented in the form of a battery which is mountable in or dismountable from the photographing apparatus 100. The size and weight of the battery are an important issue in miniaturizing the photographing apparatus 100.

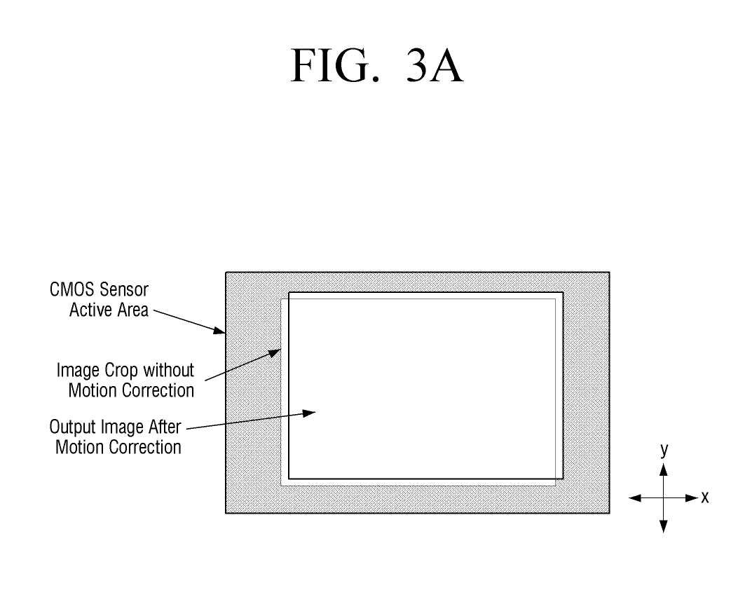

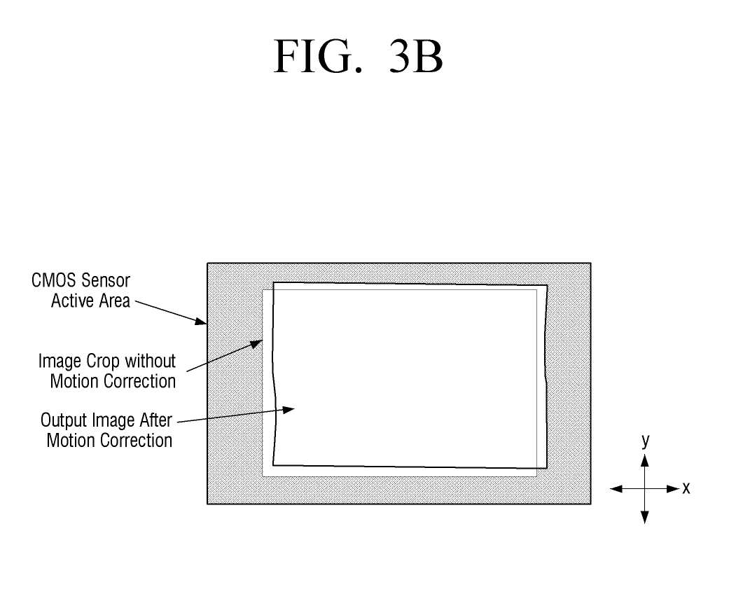

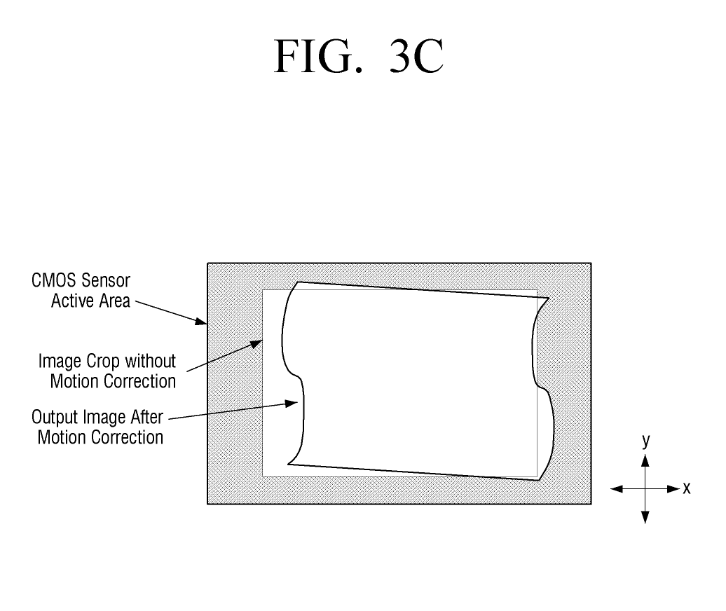

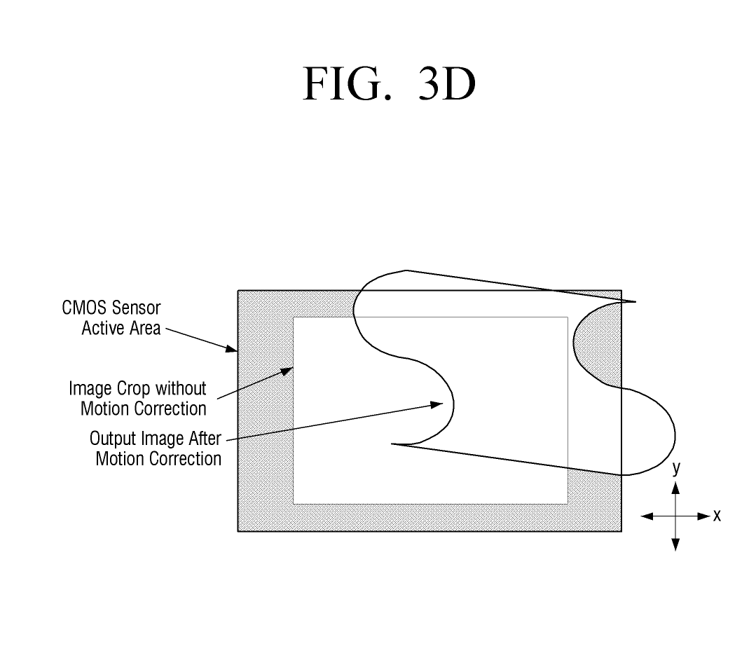

The controller 140 controls the above-described elements of the photographing apparatus 100 and the elements of the photographing apparatus 100 which are not illustrated. The operation of the controller 140 will be explained below with reference to FIGS. 3A to 5.

According to an exemplary embodiment, the controller 140 may classify motion scenarios of the photographing apparatus 100 based on shaking information and motion estimation information. There are three primary reasons to compensate for a motion. A motion caused by the translation motion, a motion caused by the rotary motion, and distortion caused by a rolling shutter are the three reasons. These reasons complexly affect the output of the photographing operation. In the exemplary embodiment, there are four motion scenarios. FIGS. 3A to 3D illustrate images before and after motion compensation is processed according to each motion scenario. Frames are read from the entirety of the CMOS sensor active area of the photographing apparatus 100, but the size of a real frame used in a content such as a moving image is smaller than the read frame. In other words, the controller 140 controls the image processor 130 to crop the image. In FIGS. 3A to 3D, the cropped part of the image is located in the middle of the CMOS sensor active area. Therefore, the part of the image to be cropped before motion compensation is processed is illustrated in the middle in a rectangular form.

FIG. 3A is a view illustrating a first scenario. The first scenario is created by considering a case in which the user holds and fixes the photographing apparatus 100. In the first scenario, only small shaking is considered. Therefore, in the first scenario, the controller 140 has only to control the image processor 130 to process correction with respect to only the translation motion. However, when the photographing apparatus 100 pans in the direction of x or y, the compensation process is required even if the rotational motion is small. In this case, motion estimation information is required in addition to shaking information detected by the sensor 120. This will be explained in detail below.

FIG. 3B is a view illustrating a second scenario. The second scenario is created by considering a case in which the location of the user is not moved and the user photographs while moving the photographing apparatus 100 vertically and horizontally. Compared with the case of FIG. 3A, the scenario of FIG. 3B may include additional pixels or include less pixels due to shaking compensation because a vertical direction boundary of an outputted image is not a straight line. In the second scenario, the controller 140 may control the image processor 130 to perform correction processing according to a general image processing method.

FIG. 3C is a view illustrating a third scenario. The third scenario is created by considering a case in which the photographing apparatus 100 is greatly shaken, such as a case in which the user photographs while walking. A cropped output image is different from a rectangular image constituting a moving image frame. The controller 140 may control the image processor 140 to reconstruct the frame based on data in the cropped output image.

FIG. 3D is a view illustrating a fourth scenario. The fourth scenario is created by considering a case in which the user photographs while making a big motion, such as running. The fourth scenario requires the most comprehensive calculation and much power consumption to process the image. For example, when the image is out of the CMOS sensor active area, the controller 140 requires compensation processing such as generating an interpolation frame by the image processor 130. However, an enhancement effect in image quality is not great in comparison to power consumed to process the image. Therefore, it is effective to perform simple image processing and prevent power consumption. In the fourth scenario, the controller 140 controls the image processor 130 to perform correction processing with respect to only the translation motion.

Therefore, when the shaking is extremely small or great, that is, at both extremes, the controller 140 may control the image processor 130 to process the image in the first processing mode. In addition, when the motion compensation processing guarantees enhancement in image quality as shown in FIGS. 3B and 3C, the controller 140 may control the image processor 130 to process the image in the second processing mode.

The first processing mode is a processing mode which is performed when it is more effective to reduce power consumption than to process image correction. Because the image correction processing is not required or an enhancement effect in image quality by the image correction processing is hardly exhibited, the correction is performed with respect to only the translation motion in the first processing mode. The second processing mode is a processing mode in which general image correction processing is performed. In the second processing mode, the motion caused by the rotational motion, the rotary motion, and the distortion caused by the rolling shutter is compensated.

The controller 140 determines a processing mode for processing a moving image based on at least one of shaking information detected through the sensor 120 and motion estimation information. Hereinafter, a detailed determination process will be explained.

According to an exemplary embodiment, the controller 140 may compare a value extracted from shaking information and a first threshold. For example, the value extracted from the shaking information may be an angular velocity, a rotation direction displacement value, or the like. When the value extracted from the shaking information is less than or equal to the first threshold, the controller 140 determines that there is little motion as shown in FIG. 3A. In this case, motion estimation information should be additionally analyzed as described above. This is because image enhancement is preferred over prevention of power consumption when the photographing apparatus pans even if shaking in the rotation direction is little extracted from the gyro sensor.

The controller 140 analyzes the motion estimation information and compares the number of unidirectional motion data and a predetermined number. The motion estimation information refers to information which is estimated based on the result of image processing of the previous frames in the image processor 130. For example, the image processor 130 may extract a motion vector by comparing the plurality of frames. The controller 140 may determine the number of unidirectional motion data by analyzing the extracted motion vector. In response to the number of unidirectional motion data being less than or equal to the predetermined number, the controller 140 controls the image processor 130 to process the image in the first processing mode. When the number of unidirectional motion data is less than or equal to the predetermined number, there is little translation motion and thus the controller 140 determines the processing mode as the first processing mode.

To the contrary, in response to the number of unidirectional motion data exceeding the predetermined number, the controller 140 controls the image processor 130 to process the image in the second processing mode. The number of unidirectional motion data exceeding the predetermined number means that the photographing apparatus 100 pans in a certain direction. Therefore, the controller 140 determines the processing mode as the second processing mode.

According to an exemplary embodiment, in response to the value extracted from the shaking information exceeding the first threshold, the controller 140 compares the value extracted from the shaking information and a second threshold to distinguish the case in which the motion is extremely great and thus there is no need to process the image. In this case, the second threshold should be greater than the first threshold. In response to the value extracted from the shaking information exceeding the second threshold, the controller 140 controls the image processor 130 to process the image in the first processing mode. To the contrary, in response to the value extracted from the shaking information being less than or equal to the second threshold, the controller 140 may control the image processor 130 to process the image in the second processing mode. When the value extracted from the shaking information exceeds the second threshold, that is, when the motion is extremely great as shown in FIG. 3D, it is effective not to use resources required to process the image. Therefore, the controller 140 determines the processing mode as the first processing mode. When the value extracted from the shaking information is less than or equal to the second threshold, it is possible to expect the enhancement effect in image quality through correction processing as shown in FIG. 3B or 3C. Therefore, the controller 140 determines the processing mode as the second processing mode.

The first threshold and the second threshold may be set differently according to the performance of the photographing apparatus 100. Whether to consume power to process the image is determined by considering the compensation processing performance and the battery power.

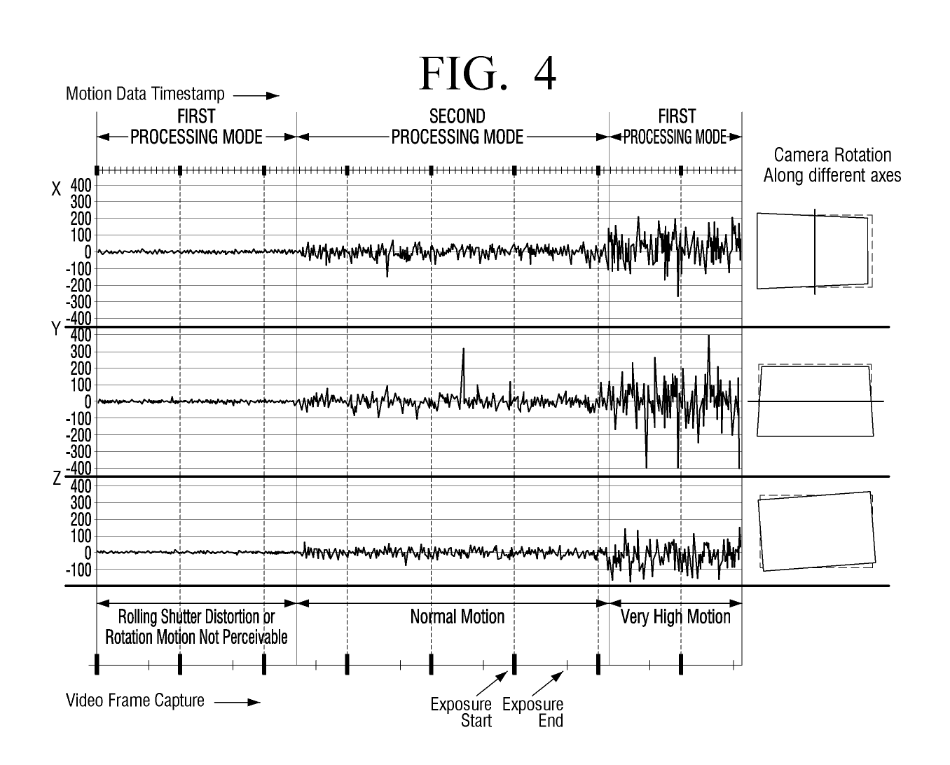

FIG. 4 is a view showing shaking information which is detected by the sensor 120 of the photographing apparatus 100 according to an exemplary embodiment. FIG. 4 illustrates a graph showing a record of shaking caused by rotation of the photographing apparatus 100 about 3 axes of x, y, and z with time. When there is little shaking in the early stage of measurement and thus the user scarcely recognizes the shaking, there is no need to perform correction. Therefore, the controller 140 controls the image processor 130 to process the image in the first processing mode. Thereafter, when the moderate degree of shaking is detected, the controller 140 controls the image processor 130 to process the image in the second processing mode. Finally, when the shaking is extremely great, the enhancement effect in image quality is hardly exhibited even if the image is processed. Therefore, the controller 140 controls the image processor 130 to process the image in the first processing mode.

FIG. 4 illustrates a time to capture frames at the lower part. The photographer 110 captures the frames during a time between a time at which exposure starts and a time at which exposure ends. Because the shaking information is variable on a real time basis while the frames are captured, the controller 140 may compare an average value of the shaking information measured during the time required to capture the frames (a time between the exposure start time and the exposure end time) and the first threshold. In this case, the value extracted from the shaking information may be the average value of the shaking information measured while the frames are captured.

According to an exemplary embodiment, after determining in which processing mode the image is processed, the controller 140 controls the image processor 130 to process the image in the determined processing mode.

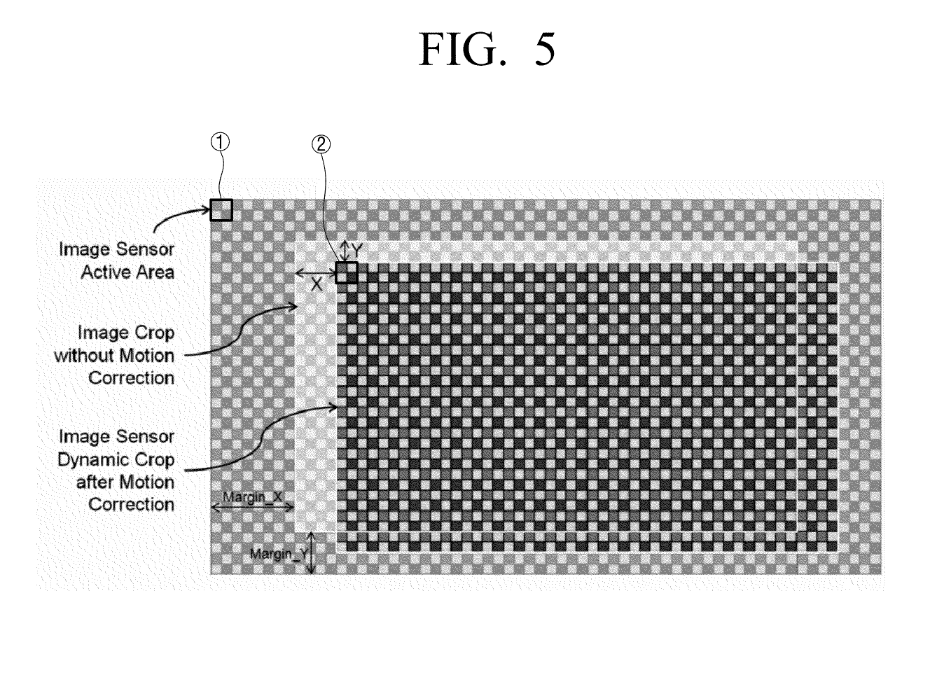

FIG. 5 is a view to illustrate translation motion correction processing in the first processing mode. In response to the determined processing mode being the first processing mode, the controller 140 may control the image processor 130 to process correction with respect to only the translation motion by performing dynamic crop with a translation motion offset. The translation motion offset is determined based on the shaking information detected by the sensor 120.

In an image processing process of the related art, all the pixels are read from the CMOS sensor active area first and then only a predetermined area is cropped and stored as an output frame. On the other hand, in the first processing mode, the output frame is stored in a dynamic crop method. The dynamic crop refers to a method which estimates a location of a predetermined area to be cropped, reads only the pixels of the corresponding area, and directly stores the pixels. For example, in the image processing process in FIG. 5 of the related art, reading starts from pixel \textcircled{1} and all the pixels are read in the rolling shutter method. To the contrary, the dynamic crop reads only the pixels corresponding to a frame outputted from pixel \textcircled{2}.

‘X’ and ‘Y’ values shown next to pixel \textcircled{2} correspond to the translation motion offset. The translation motion offset is determined based on the shaking information detected by the sensor 120. For example, a method for calculating the ‘X’ value, that is, a translation motion offset in the x-axis direction will be explained. An angular velocity value is measured while a first frame is captured by the gyro sensor of the sensor 120. A translation motion distance during the time between the time at which the exposure of the first frame ends and the time at which exposure of a second frame starts is the translation motion offset. The translation motion offset is determined by a combination of focal length information of the photographing apparatus 100 and the angular velocity value at the X and Y axes.

In response to the translation motion offset being determined, the controller 140 may determine a pixel from which image processing starts in the dynamic crop by adding the translation motion offset calculated from the capturing point of the previous frame. Because the number of pixels to be read can be reduced by using the dynamic crop in the first processing mode, power consumption can be reduced.

In the first processing mode, the power consumption can be reduced not only in the pixel reading process but also in the process of storing the output frame after image processing. In the image processing process of the related art, the pixels read out from the CMOS sensor are stored in the input frame buffer 151 first. Next, the controller 140 controls the image processor 130 to read the data stored in the input frame buffer 151 and process the image. In addition, the controller 140 may control the storage 150 to store the output frame which is generated by processing the image in the output frame buffer 153. In such an image processing process, the process of storing and reading in the input frame buffer 151 requires much power consumption.

To the contrary, in the first processing mode of the exemplary embodiment, data is read only from pixels of a part corresponding to the output frame in the dynamic crop and is directly stored in the output frame buffer 153. That is, the controller 140 controls the storage 150 to directly store the frame which undergoes correction for only the translation motion in the output frame buffer 153. Therefore, in the first processing mode, the power consumption can also be reduced in the method of storing the frame in comparison to the general image processing method.

According to an exemplary embodiment, the controller 140 may monitor the status of the photographing apparatus 100. In response to the status of the photographing apparatus 100 reaching a predetermined threshold, the controller 140 may determine the processing mode as the first processing mode regardless of the shaking information or the motion estimation information. In addition, the controller 140 controls the image processor 130 to process the image in the first processing mode.

For example, the status of the photographing apparatus 100 may be at least one of a battery level, a temperature level, a CPU active core, ambient light, and a zoom level. From among these, the battery level, the temperature level, and the CPU active core are related to a device limitation of the photographing apparatus 100. In addition, the ambient light and the zoom level are less related to the enhancement effect in image quality even when correction processing is performed.

When the battery level is low, the temperature level is low, or the available CPU active core is insufficient, image processing for video stabilization cannot be performed. Therefore, the controller 140 may control the image processor 130 to process the image in the first processing mode in which power is less consumed forcedly.

When the ambient light is low or the digital zoom level is high, the quality of image frames before image processing is performed is very low, and thus, an enhancement effect in image quality is hardly exhibited. For example, when there is no ambient light and thus photographing is performed in darkness, the photographed image may be a black screen. Therefore, the image processing effect is hardly exhibited. Therefore, the controller 140 controls the image processor 130 to process the image in the first processing mode in which power is less consumed regardless of the shaking information.

According to the exemplary embodiments as described above, when an image enhancement effect is hardly attained, the photographing apparatus 100 can reduce power consumption while maintaining a video stabilization effect, by excluding a part of the image processing process.

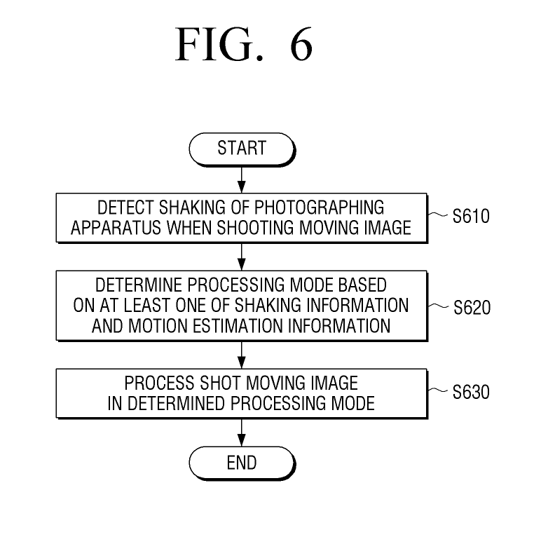

Hereinafter, a method for controlling a photographing apparatus 100 according to various exemplary embodiments will be explained with reference to FIGS. 6 to 10.

FIG. 6 is a flowchart to illustrate a method for controlling a photographing apparatus 100 according to an exemplary embodiment. The photographing apparatus 100 detects shaking when a moving image is photographed (S610). For example, the photographing apparatus 100 may detect rotation direction motion information using a gyro sensor embedded therein.

The photographing apparatus 100 determines a processing mode for photographing the moving image based on at least one of shaking information detected and motion estimation information (S620). Finally, the photographing apparatus 100 processes the photographed moving image in the determined processing mode (S630). The operations of determining the processing mode and processing the photographed moving image will be explained in detail below.

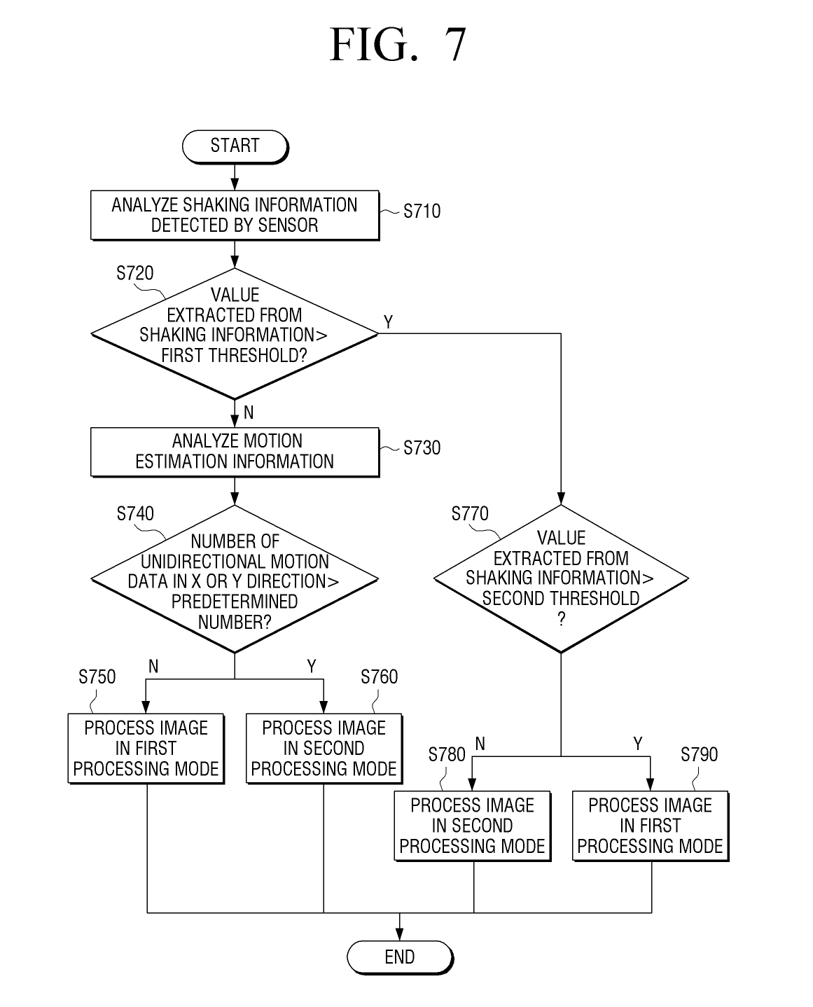

FIG. 7 is a flowchart to illustrate a process of determining a processing mode in detail. Referring to FIG. 7, the photographing apparatus 100 analyzes shaking information detected by a sensor first (S710). The photographing apparatus 100 uses the shaking information first out of the shaking information and motion estimation information. The photographing apparatus 100 compares a value extracted from the shaking information and a first threshold (S720). For example, the value extracted from the shaking information may be an average value of angular velocity values detected from a time at which exposure for capturing frames starts to a time at which exposure ends. In this operation, the photographing apparatus 100 distinguishes between a case in which there is little shaking and the other cases.

In response to the value extracted from the shaking information being less than or equal to the first threshold (S720-N), the photographing apparatus 100 additionally analyzes motion estimation information (S730). When there is little shaking, the photographing apparatus 100 needs to distinguish between a case in which the photographing apparatus 100 pans and a case in which the photographing apparatus 100 is not moved. Accordingly, the photographing apparatus 100 analyzes the motion estimation information and determines whether the number of unidirectional motion data in the direction of x or y is greater than a predetermined number or not (S740).

In response to the number of unidirectional motion data being less than or equal to the predetermined number (S740-N), it may be determined that the photographing apparatus 100 is scarcely moved. Therefore, the photographing apparatus 100 processes the image in the first processing mode (S750). To the contrary, in response to the number of unidirectional motion data exceeding the predetermined number (S740-Y), it may be determined that the photographing apparatus 100 pans. In this case, the photographing apparatus 100 processes the image in the second processing mode in which enhancement in image quality is more important than prevention of power consumption (S760).

In response to the value extracted from the shaking information exceeding the first threshold (S720-Y), the photographing apparatus 100 should determine whether the shaking is so great that motion compensation processing is useless. The photographing apparatus 100 compares the value extracted from the shaking information and a second threshold (S770). In this case, the second threshold should be greater than the first threshold. The first threshold and the second threshold may be set differently according to the performance of the photographing apparatus 100.

In response to the value extracted from the shaking information being less than or equal to the second threshold (S770-N), the photographing apparatus 100 processes the image in the second processing mode (S780). To the contrary, in response to the value extracted from the shaking information exceeding the second threshold (S770-Y), it is determined that the shaking is extremely great and thus it is more effective to prevent power consumption than to process motion compensation. Therefore, the photographing apparatus 100 processes the image in the first processing mode (S790).

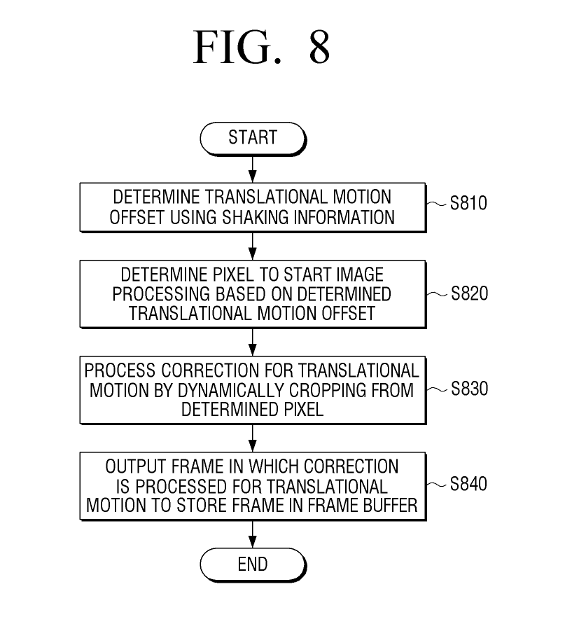

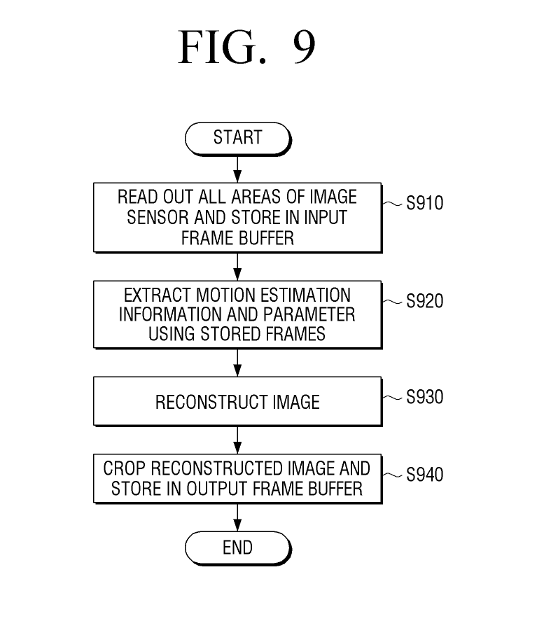

FIGS. 8 and 9 are flowcharts showing a process of processing an image in the first mode and the second mode, respectively, in detail.

Referring to FIG. 8, the photographing apparatus 100 determines a translation motion offset using shaking information in the first processing mode (S810). For example, the translation motion offset may be calculated by multiplying an angular velocity measured by a gyro sensor by a time between focal length and frame capturing. In addition, the photographing apparatus 100 may determine a pixel from which image processing starts based on the determined translation motion offset (S820). Because the dynamic crop used in the first processing mode does not read all the pixels on a CMOS sensor active area and reads only the pixels corresponding to an output frame, a pixel from which image processing starts should be determined.

The photographing apparatus 100 determines a pixel from which image processing starts by adding an offset which is estimated as moving during a time between a time at which capturing of a previous frame ends and a time at which capturing of a current frame starts to the location from which the previous frame is read. The photographing apparatus 100 processes correction with respect to the translation motion by performing dynamic crop from the determined pixel (S830). In addition, the photographing apparatus 100 stores the frame which undergoes the correction processing for the translation motion in the output frame buffer (S840). Because the process of storing and reading in the input frame buffer is omitted in the first processing mode, power consumption can be further reduced.

Referring to FIG. 9, in the second processing mode, the photographing apparatus 100 reads pixels from the entire area of an image sensor and stores the pixels in the input frame buffer (S910). In addition, the photographing apparatus 100 extracts motion estimation information and extracts motion parameters using the stored frame (S920). For example, the motion estimation information may include a motion vector or etc. The photographing apparatus 100 reconstructs the image based on the extracted motion estimation information (S930). Thereafter, the photographing apparatus 100 crops the reconstructed image and stores the image in the output frame buffer (S940). In the second processing mode, the processes of reading from the entire area of the image sensor, passing through the input frame buffer, extracting the motion estimation information, and reconstructing the image are required and thus consume much power in comparison with the first processing mode.

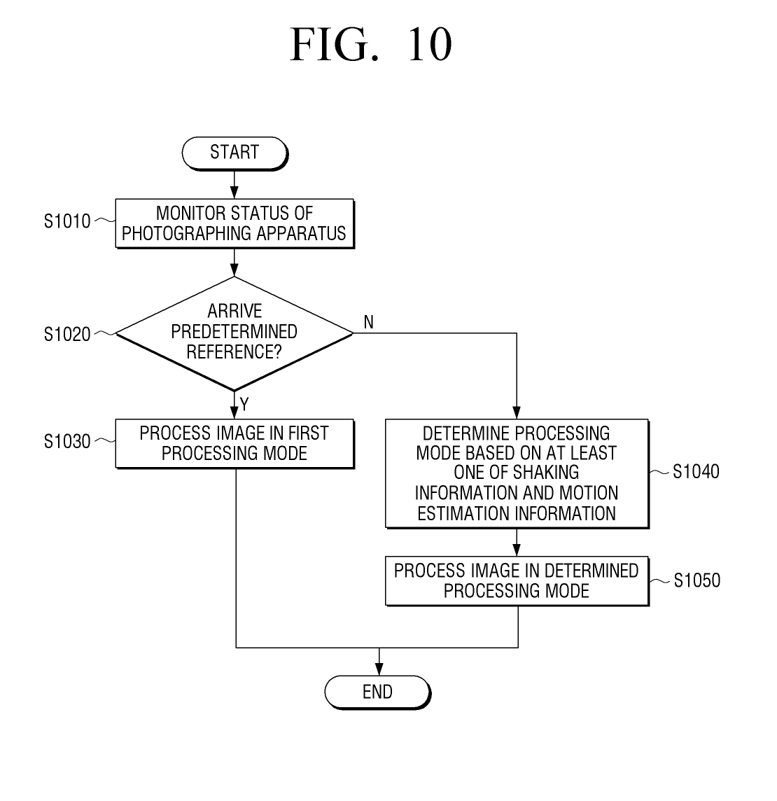

FIG. 10 is a view to illustrate a method for controlling a photographing apparatus 100 according to another exemplary embodiment. The photographing apparatus 100 may determine a processing mode according to the status of the photographing apparatus 100. The photographing apparatus 100 always monitors the status of the photographing apparatus 100 (S1010). For example, the status of the photographing apparatus 100 may be at least one of a battery level, a temperature level, the number of usable CPU active cores, ambient light, and a zoom level including a digital zoom.

The photographing apparatus 100 determines whether the status of the photographing apparatus 100 reaches a predetermined reference or not (S1020). In response to the status of the photographing apparatus 100 not reaching the predetermined reference (S1020-N), the photographing apparatus 100 determines a processing mode based on at least one of shaking information and motion estimation information again (S1040). Thereafter, the photographing apparatus 100 processes the image in the determined processing mode (S1050).

To the contrary, in response to the status of the photographing apparatus 100 reaching the predetermined reference (S1020-Y), the photographing apparatus 100 processes the image in the first processing mode regardless of the shaking information and the motion estimation information (S1030). When the status of the photographing apparatus 100 reaches the predetermined reference, the performance of the photographing apparatus or the motion compensation effect is hardly achieved. Therefore, the photographing apparatus 100 processes the image in the first processing mode in which power is less consumed.

According to the method for controlling the photographing apparatus 100 according to various exemplary embodiments described above, the photographing apparatus 100 distinguishes between the case in which much power should be consumed and the case in which power consumption should be prevented, and thus can provide an effective power consumption method and simultaneously achieve a video stabilization effect.

In addition, a program code for performing the method for controlling according to various exemplary embodiments as described above may be stored in various kinds of recording media. Specifically, the program code may be stored in various kinds of recording media from which data is readable in a terminal, such as a Random Access Memory (RAM), a flash memory, a Read Only Memory (ROM), an Erasable Programmable ROM (EPROM), an Electronically Erasable and Programmable ROM (EEPROM), a register, a hard disk, a removable disk, a memory card, a USB memory, and a CD-ROM.

While exemplary embodiments have been particularly shown and described above, it would be appreciated by those skilled in the art that various changes may be made therein without departing from the principles and spirit of the inventive concept, the scope of which is defined in the following claims.

What is claimed is:

1. A photographing apparatus comprising:
a photographer configured to photograph a moving image;
a sensor configured to detect shaking of the photographing apparatus;
an image processor configured to correct a photographed frame of the photographed moving image; and
a controller configured to determine a processing mode for processing the photographed moving image based on at least one of shaking information of the photographing apparatus which is detected through the sensor and motion estimation information of the photographed moving image, and to control the image processor to process the moving image in the determined processing mode.

2. The photographing apparatus of claim 1, wherein the controller is configured to compare a value extracted from the shaking information and a first threshold, and, in response to the value being less than or equal to the first threshold, the controller is configured to analyze the motion estimation information and to determine the processing mode for processing the photographed moving image, and, in response to the value exceeding the first threshold, the controller is configured to compare the value extracted from the shaking information and a second threshold and to determine the processing mode for processing the photographed moving image.

3. The photographing apparatus of claim 2, wherein the controller is configured to analyze the motion estimation information, and, in response to a number of unidirectional motion data being less than or equal to a predetermined number, the controller is configured to control the image processor to process the image in a first processing mode, and, in response to the number of unidirectional motion data exceeding the predetermined number, the controller is configured to control the image processor to process the image in a second processing mode.

4. The photographing apparatus of claim 2, wherein, in response to the value extracted from the shaking information exceeding the second threshold, the controller is configured to control the image processor to process the image in a first processing mode, and, in response to the value being less than or equal to the second threshold, the controller is configured to control the image processor to process the image in a second processing mode.

5. The photographing apparatus of claim 1, wherein, in response to the determined processing mode being a first processing mode, the controller is configured to control the image processor to process correction of the moving image with respect to only a translation motion by performing dynamic crop with a translation motion offset.

6. The photographing apparatus of claim 5, wherein the controller is configured to determine the translation motion offset based on the shaking information detected by the sensor, and
wherein the dynamic crop determines a pixel from which image processing starts using the translation motion offset and crops the image.

7. The photographing apparatus of claim 5, further comprising:
an input frame buffer configured to store a pre-image processing frame; and
an output frame buffer configured to store a post-image processing frame, and
wherein the controller is configured to store a frame which undergoes correction processing only for the translation motion only in the output frame buffer amongst the input frame buffer and the output frame buffer.

8. The photographing apparatus of claim 1, wherein the motion estimation information is information which is estimated based on a result of image processing of preceding frames of the photographed frame.

9. The photographing apparatus of claim 1, wherein the controller is configured to monitor a status of the photographing apparatus, and, in response to the monitored status of the photographing apparatus reaching a predetermined threshold, the controller is configured to determine the processing mode as a first processing mode regardless of the shaking information and the motion estimation information, and to control the image processor to process the image in the first processing mode.

10. The photographing apparatus of claim 9, wherein the monitored status of the photographing apparatus comprises at least one of a battery level, a temperature level, a CPU active core, ambient light, and a zoom level.

11. A method for controlling a photographing apparatus, the method comprising:
detecting, by a sensor, shaking of the photographing apparatus when photographing a moving image;
determining, by a controller, a processing mode for processing the moving image based on at least one of the detected shaking information of the photographing apparatus and motion estimation information of the photographed moving image; and
processing, by at least one processor, the moving image in the determined processing mode.

12. The method of claim 11, wherein the determining comprises comparing a value extracted from the shaking information and a first threshold, and, in response to the value being less than or equal to the first threshold, analyzing the motion estimation information and determining the processing mode for processing the moving image, and, in response to the value exceeding the first threshold, comparing the value extracted from the shaking information and a second threshold and determining the processing mode for photographing the moving image.

13. The method of claim 12, wherein the determining comprises analyzing the motion estimation information, and, in response to a number of unidirectional motion data being less than or equal to a predetermined number, determining the processing mode as a first processing mode, and, in response to the number of unidirectional motion data exceeding the predetermined number, determining the processing mode as a second processing mode.

14. The method of claim 12, wherein the determining comprises, in response to the value extracted from the shaking information exceeding the second threshold, determining the processing mode as a first processing mode, and, in response to the value being less than or equal to the second threshold, determining the processing mode as a second processing mode.

15. The method of claim 11, wherein the processing comprises, in response to the determined processing mode being a first processing mode, processing correction of the moving image with respect to only a translation motion by performing dynamic crop with a translation motion offset.

16. The method of claim 15, wherein the translation motion offset is determined based on the detected shaking information, and
wherein the dynamic crop determines a pixel from which image processing starts using the translation motion offset and crops the image.

17. The method of claim 15, wherein the processing comprises storing a frame which undergoes correction processing only for the translation motion in an output frame buffer amongst the output frame buffer and an input frame buffer.

18. The method of claim 11, wherein the motion estimation information is information which is estimated based on a result of image processing of preceding frames of the photographed moving image.

19. The method of claim 11, wherein the determining comprises monitoring a status of the photographing apparatus, and, in response to the monitored status of the photographing apparatus reaching a predetermined threshold, determining the processing mode as a first processing mode regardless of the shaking information and the motion estimation information.

20. The method of claim 19, wherein the monitored status of the photographing apparatus comprises at least one of a battery level, a temperature level, a CPU active core, ambient light, and a zoom level.
